(19) United States
(12) Patent Application Publication
(10) Pub. No.: US 2012/0259762 A1
(43) Pub. Date: Oct. 11, 2012

(54) Network-Based Systems, Methods, and Apparatuses for Constructing and Executing Transactions

(76) Inventors: Amir Tarighat, Reseda, CA (US); Adam Demos, New York, NY (US); Christopher Ivey, Litchfield, CT (US)

(21) Appl. No.: 13/444,327

(22) Filed: Apr. 11, 2012

Related U.S. Application Data
(60) Provisional application No. 61/474,021, filed on Apr. 11, 2011.

(51) Int. Cl. G06Q 40/04; G09G 5/00; G06Q 40/00

(52) U.S. Cl. 705/37; 705/35; 345/676

(57) ABSTRACT

In part, the invention relates a graphical trading algorithm platform configured to construct algorithms for execution in a cloud computing environment and related methods. In one embodiment, an exemplary method includes displaying a plurality of drag and droppable widgets within a computer generated graphical environment, each icon associated with a component of an event algorithm; processing a plurality of the widgets in a predetermined order when such widgets are arranged in a sequence corresponding to steps in the event algorithm; monitoring data feeds relating to an event of interest, wherein the event of interest is selected from the group comprising of stock changes, news events, market events, and regulatory events; and executing the action within a time period P when conditions defined by the event algorithm are satisfied.

### RELATED APPLICATIONS

This application claims the benefit under 35 U.S.C. §119(e) to U.S. Provisional Application No. 61/474,021 filed on Apr. 11, 2011, the disclosure of which is herein incorporated by reference in its entirety.

### FIELD OF THE INVENTION

In part, the invention relates to the field of computer technologies and software such as cloud computing and graphical user interfaces.

### BACKGROUND

The prevalence and growing dependence on computers and mobile devices has changed many predicate industries. Travel booking, shopping, and watching movies have been transformed by online versions of traditional phone-based or brick and mortar industries. The business of buying and selling stocks has also going through several transformations given the power of modern computers and the ability to communicate trades over the internet.

Specifically, online brokerage accounts allow consumers to buy and sell stocks with out a stockbroker. Unfortunately, the interfaces are typically limited to fillable forms and buttons and the range of trading options are sparse (buy, sell, limit order, stop limit order, etc.). Accordingly, a need exists for trading platforms and related systems, methods, and networks that can provide an improved user interface and offer users the ability to expand and modify their trading options and techniques without developing new software and applications for each change.

### SUMMARY OF THE INVENTION

In part, one embodiment of the invention relates to a drag and drop interface in which an active portion of the screen or interface region receives widgets having associated features and customizable parameters. The widgets represent components of an infinite set of trading algorithms. The widgets may be combined with and may include various operators such as logical or Boolean operators to create algorithms for monitoring and/or affecting the trading of an asset such as a security or commodity. Various methods, data structures, logical elements, software, and hardware components used to provide a graphical environment within which trading rules and algorithms may be constructed and subsequently implemented in the market or simulated are described herein. Each of the foregoing elements and the others described below, either alone, or in combination are referred to as a trading platform or system.

In part, the invention relates to graphic programming of financial trading algorithms, routines, models or rules. The graphical interfaces can be configured to relay information over a network such that a trade can be generated as part of a cloud network implemented platform. The routines or other algorithms may include one or more logical components or a function that includes parameters such that an icon is linked to or associated with a logical component or function. In one embodiment, the system includes a construction set configured to build algorithms using logical modules or components represented by widgets. In addition, trading algorithms or processes can be constructed that include responsive inputs to real time events such as news events. For example, in one embodiment an event algorithm is a type of algorithm that can be constructed using drag and droppable widgets as shown herein that causes a second event to occur in response to a first event such as a data stream input or other trigger. An event algorithm can be a trading algorithm wherein the second event relates to a transaction event such as executing a trade. In one embodiment, the invention also includes a testing simulator for graphically programmed algorithms using historical trading data that are designed to run based on various updateable assumptions. Further, in one embodiment, the system includes a scalable software and network architecture that allows numerous algorithms to run on any financial exchange or market in the world.

In addition, the invention relates to various hardware and network topologies suitable for high speed trading and remote algorithmic trade execution. One system embodiment may include a cloud exchange system or other system that includes a control node. In one embodiment, the control node routes a pre-built or constructed algorithm to the proper execution server such as a proximity server. In one embodiment, the term “proximity server” refers to a server is geographically proximal to the financial exchange with respect to which it executes a portion of its trades or algorithmic trading steps.

In turn, an execution server may be implemented that executes trades using events of interest such as news and technical data feeds from graphical programmed algorithms. In addition, in one embodiment, one or more servers are used such that one or more algorithms may run on two different proximity execution servers. For example, a proximity server in the U.S. and a proximity server in Japan may both be communicating with each other and each may be running the same algorithm that uses currency fluctuations with respect to each country as an input. Such an embodiment is desirable when implementing a currency arbitrage strategy. In one embodiment, the algorithms can run independently of each other to maintain ultra-low latent speeds, and also reduces the effects of slippage such as how it relates to transaction cost variation. This is in contrast to one server that is equidistant from two other computers participating in a trade or data exchange.

In one embodiment, execution servers are connected as a grid or other suitable network topology. The arrangement and connection of the servers facilitates load balancing and data sharing in terms of the various processing, monitoring, routing, and trading steps for a given trading algorithm. In addition, when one server is at max capacity, other servers will be able to efficiently distribute the labor. In one embodiment, when a control node sends an output, such as a buy or sell order, associated with a trading algorithm to a proximity server, a plurality of servers may be used.

In one embodiment of the invention, three servers are used. The first can be configured to perform administrative tasks and includes a memory storage device with one or more administrative programs. The second server can be configured to run trading algorithms and includes a memory storage device with one or more algorithmic trading related programs. The third server can be configured to execute trades. One or more of these servers may be geographically proximal to a given financial exchange or trading venue. Alternatively, a single server may be used, or the execution may be spread across the application server and an execution server which runs the algorithms in proximity or co-location with the exchange venue. In one embodiment, one server running multiple virtual machines can be used in lieu of three separate servers.

The embodiments described herein may also be implemented with, managed, or run from a browser, a mobile device or any computer from anywhere in the world. In one embodiment, the invention includes server side software for running the algorithms, executing trades, and communicating with the front end web application. In one embodiment, the invention includes features for wealth managers. In another embodiment, the invention includes software and controls that allows authorized money managers to control their client's algorithms. Thus, a set of trading algorithms can be created that include triggers. The level of control a manager has may be constrained with include the ability to create, edit, and turn algorithms on and off. In one embodiment, the invention includes preset triggers or thresholds such as an “emergency shut off value” function as a general override or as component icon for a given trading algorithm. For example, such a trigger or threshold would stop or pausing trading when volatility drops below a certain level.

In one embodiment, the invention includes an automated activation feature, which turns on or starts the execution of a given algorithm. For example, if the value of the U.S. dollar (USD) becomes greater than a set threshold (X) then trade “security Y” using a strategy such as a Volume-Weighted Average Price (V-WAP) strategy.

Various embodiments of the invention include hardware or network topology configurations that allow trades to execute at ultra-low latency speeds. In one embodiment, ultra-low latency speeds refers to from less than about 1 millisecond. In another embodiment, ultra-low latency speeds refers to from about 1 millisecond to about 5 milliseconds. The use of proximity servers facilitates low latency in one embodiment.

In part, one embodiment of the invention relates to simplified textual algorithm (STA) creation, simulation, or execution. By using a STA-based embodiment, a user has control over the algorithm and may specify how they want the algorithm to operate and process data, rules, logic and events of interest. In one embodiment, the invention will create a computer executable program or script using the visual programming modules.

In one embodiment, the invention relates to a computer implemented method of executing an action using a graphical user interface. The method includes displaying a plurality of drag and droppable widgets within a computer generated graphical environment, each widget associated with a component of an event algorithm; processing a plurality of the widgets in a predetermined order when such widgets are arranged in a sequence corresponding to steps in the event algorithm; monitoring data feeds relating to an event of interest, wherein the event of interest is selected from the group consisting of or comprising stock changes, news events, market events, and regulatory events; and executing the action within a time period P when conditions defined by the event algorithm are satisfied.

In one embodiment, the time period P can be a function of a routing speed of an ultra-low latency network. The step of displaying can be performed within a browser. The computer generated graphical environment can be integrated with a plurality of trading software applications. The widgets can include a first widget and one of the components includes a first component, wherein the first component is a second stock trading algorithm. The component of the event algorithm can be selected from the group consisting of a ratio, a security, a price, a logical operator, a second stock trading algorithm, a Boolean operator, an event of interest, and a conditional operator. The method can further include processing administrative operations using a control node executing on a first server, running the event algorithm on a second server, and executing the action using a third server, the action relating to a stock. The method can further include the step of combining the plurality of widgets on a client-side device. The method can further include transforming the combined widgets into a computer readable code version of the combined widgets using a server.

In one embodiment, the invention relates to computer-based system of executing an action. The system can include a server configured to transmit and receive trading data, wherein the server is geographically proximal to a trading exchange, wherein the server comprises a processor, the processor programmed to receive trading data comprising a trade order for a security transmitted from a device programmed with a trading algorithm, the trading algorithm generated using a plurality of drag and droppable widgets, each icon displayed as a widget in a browser, each icon associated with a component of the trading algorithm; and execute the action using a transformed version of a combination of the plurality of widgets such that the security is traded within a time period P, wherein the action is a trade order. In one embodiment, the server is programmed to report the execution of the trade order to the device. In one embodiment, P ranges from about 0.1 milliseconds to about 10 milliseconds. The system can further include a widget translator configured to generate the transformed version of the combination of the plurality of widgets.

In one embodiment, the invention relates to computer-based transaction system that includes a memory storage device comprising an algorithmic trading software application, the application comprising a graphic user interface comprising an active region and an algorithm builder interface; a library comprising a plurality of trading algorithm components, each component corresponding to a widget when placed in the active region; a set of widgets linked to one of the plurality of trading algorithm components; a user input monitor configured to detect selection and arrangement of each widget within the active area; and a widget translator configured to process a finalized trading algorithm and transmit any output trading orders resulting from executing the finalized trading algorithm to a proximity server. The finalized trading algorithm can be a transformed computer readable code of a plurality of widgets. The active area and widgets can be displayed within a browser.

One component can be selected from the group consisting of a ratio, a security, a price, a logical operator, a second stock trading algorithm, a Boolean operator, an event of interest, and a conditional operator. One or more widgets can be combined on a client-side device before being transformed at a server. In one embodiment, the graphical user interface can be integrated with a plurality of trading software applications. The finalized trading algorithm can be configured to have a first input populated by a real time stream of data. One or more events or states detected in the real time stream of data can cause a trade to be executed by the finalized trading algorithm.

In one embodiment, the invention relates to a computer program product for constructing a trading algorithm or an event algorithm. The computer program product includes a computer-readable tangible storage device and computer-readable program code stored thereon, the computer-readable program code comprising: computer-readable program code to display a plurality of widgets, each icon depicting a component of a trading algorithm, wherein a first icon of the plurality of widgets links to a security and a second icon of the plurality of widgets links to a logical operator; computer-readable program code to present a user interface via a display for constructing a trading routine; computer-readable program code to respond to user inputs to move and connect the first icon and the second icon to define a trading algorithm and initiate the execution of a trade with respect the security when a first condition defined in the trading algorithm occurs.

In one embodiment, the invention relates to a method of constructing a trading algorithm using a graphical user interface. The method includes displaying a plurality of drag and droppable widgets within a computer generated graphical environment, each icon associated with a component of a first stock trading algorithm; processing a plurality of the widgets in a predetermined order when such widgets are arranged in a sequence corresponding to steps in the first stock trading algorithm; monitoring data feeds relating to an event of interest, wherein the event of interest is selected from the group consisting of stock price changes, news events, market events, and regulatory events; and executing a trade such that a stock is purchased or sold within a time period P when conditions defined by the first stock trading algorithm are satisfied.

### BRIEF DESCRIPTION OF DRAWINGS

The figures are to be considered illustrative in all aspects and are not intended to limit the invention, the scope of which is defined only by the claims. The foregoing and other features and advantages of the present invention will be more fully understood from the following detailed description of illustrative embodiments, taken in conjunction with the accompanying drawings in which:

FIGS. 1A and 1B are schematic diagrams of data centers, venues, clients, application servers, and other elements that networked together in accordance with an illustrative embodiment of the invention.

FIG. 1C is a schematic diagram of network embodiment indicating various steps and data routing and transformation steps using one or more servers in accordance with an illustrative embodiment of the invention.

FIGS. 2A-2J are screenshots of graphic user interfaces showing a graphical environment or construction set in which trading algorithms or routines may be constructed and activated in accordance with an illustrative embodiment of the invention.

FIGS. 3A-3D are screenshots of graphic user interfaces of other features of various illustrative embodiments of the invention.

FIG. 4 is a process flow of a plurality of steps performed using one or more computers in accordance with an illustrative embodiment of the invention.

FIG. 5 is an exemplary architecture of a platform in accordance with an illustrative embodiment of the invention.

FIGS. 6A-8C are screenshots of graphic user interfaces showing a graphical environment or construction set in which trading algorithms or routines may be constructed and activated in accordance with an illustrative embodiment of the invention.

### DETAILED DESCRIPTION

In part, the invention relates to various computer-based trading strategies and related platforms. Specifically, the invention relates to computer-based systems and methods for constructing, executing, simulating and implementing algorithmic trading systems. Thus, in part, embodiments of the invention relate to systems, methods and devices that work with, enhance or include a computer program for entering trading orders where a computer algorithm decides aspects of the order such as the timing, price, or quantity, and in many cases initiates the order without human intervention.

In part, one aspect of the invention relates to the design, marketing and distribution of a platform to provide wider access to algorithmic trading capabilities. Embodiments of the present invention allow non-programmers and non-mathematicians to create, execute and interact with complex algorithmic or quantitative trading. The trading platform includes an intuitive visual programming interface with drag-and-drop capabilities for algorithm creation (user-friendly GUI). In addition, the platform may include a back-end cloud exchange system that may execute trades at ultra-low latency by hosting or executing trades on behalf of the user. In one embodiment, a trading algorithm is generated using a browser or other user interfaces and transmitted over a network to a remote server where the trading algorithm is subsequently executed.

The systems and methods described herein are suitable for use by anyone interested in assets such as securities. Users of the system may include, without limitation, day traders, sophisticated individual investors, value investors, and casual traders, proprietary traders, or traders at financial firms. In addition, the embodiments described herein are suitable for use by hedge funds and financial advisers that manage client assets.

In one embodiment, the system and methods described herein are targeted to active traders such as those individuals that trade more than 10 times a month. Given an active trader's the deep interest in the markets, it follows that the enhanced options and ability to trade on a substantially automated basis would appeal to such traders. Further, given the commission structure and competition among various online brokerages, the feature set of certain embodiments of the platform and the appeal to active traders makes those embodiments described herein advantageous for licensing and other monetization schemes, such as subscription models and trading algorithm sales or rentals.

Embodiments of the invention can be designed for use by traders at institutional firms as well, including, but not limited to, traders that are not computer programmers or do not have an extensive knowledge of mathematics, or those who cannot afford to buy the infrastructure to trade themselves.

In further support of the value proposition to online brokerages, it follows that by implementing a construction kit for generating algorithmic trading models and a marketplace to sell them, that daily average revenue trades or DARTs increase for the entity offering the software. In addition, the embodiments described herein may allow a licensee of a given embodiment to increase their user base as a result of offering a graphical environment for algorithmic trading that has advantages relative to other product offerings. In addition, rather than being bundled with an existing online brokerage, the embodiments described herein may operate independently of existing brokerages and compete with the same. For example, under a standalone model, one embodiment of the invention allows a lower cost per trade because of the higher volume of trades that will be executed.

In part, one embodiment of the invention includes a graphic interface that is easy to use and significantly increases the tools and trading strategies available to investors. The embodiments and features described herein can distinguish an online brokerage implementing the graphical approaches described herein relative to one that conducts trades in a conventional manner.

The embodiments of the invention described herein may be implemented using various computer and server-based architectures. One embodiment includes a real-time trading application. This may be implemented using various hardware and software features that achieve ultra-low latency from the moment an event occurs until the moment a related trade is executed.

In one embodiment, the system includes a Platform as a Service (PaaS) provider. One embodiment of the invention includes the infrastructure needed to run a client's algorithms over the internet, or other wide-access network. As a result, clients do not need to worry about trading speeds as such issues are handled using a cloud-based system. This addresses the problem associated with performing a computationally intensive trading algorithm on a home computer and dealing with the fact that personal computers are not always available to receive triggers and engage in trades. A cloud-based model solves both of these challenges.

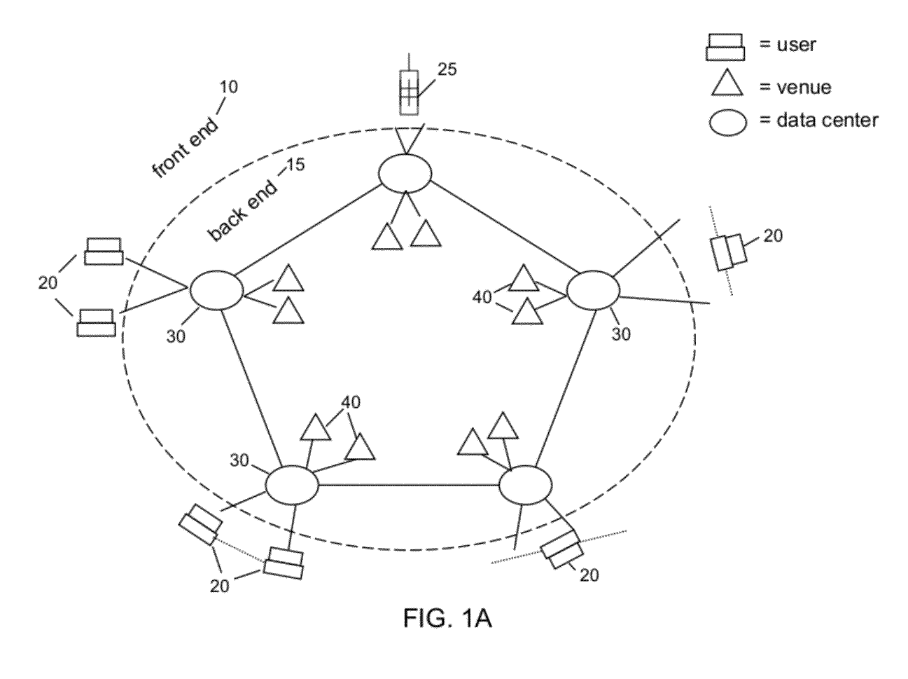

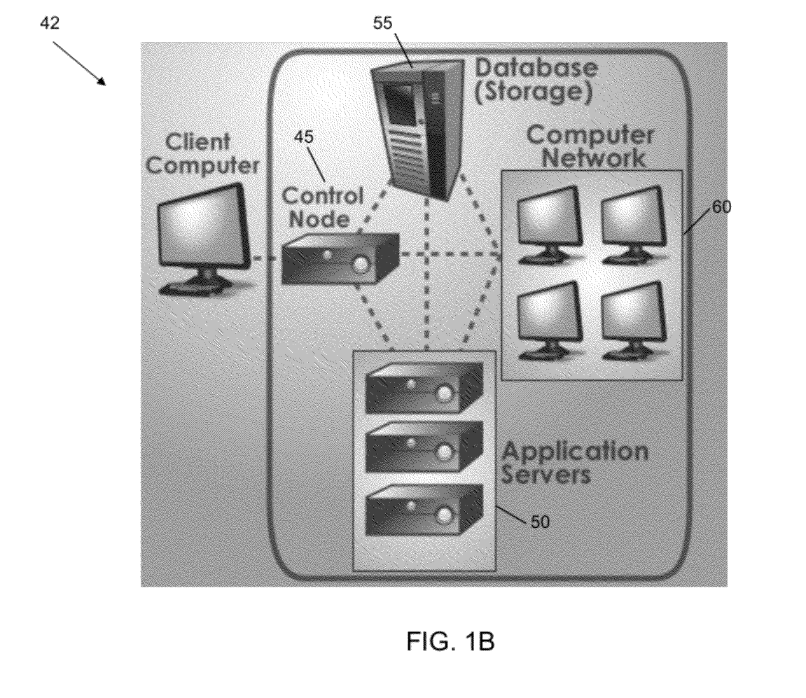

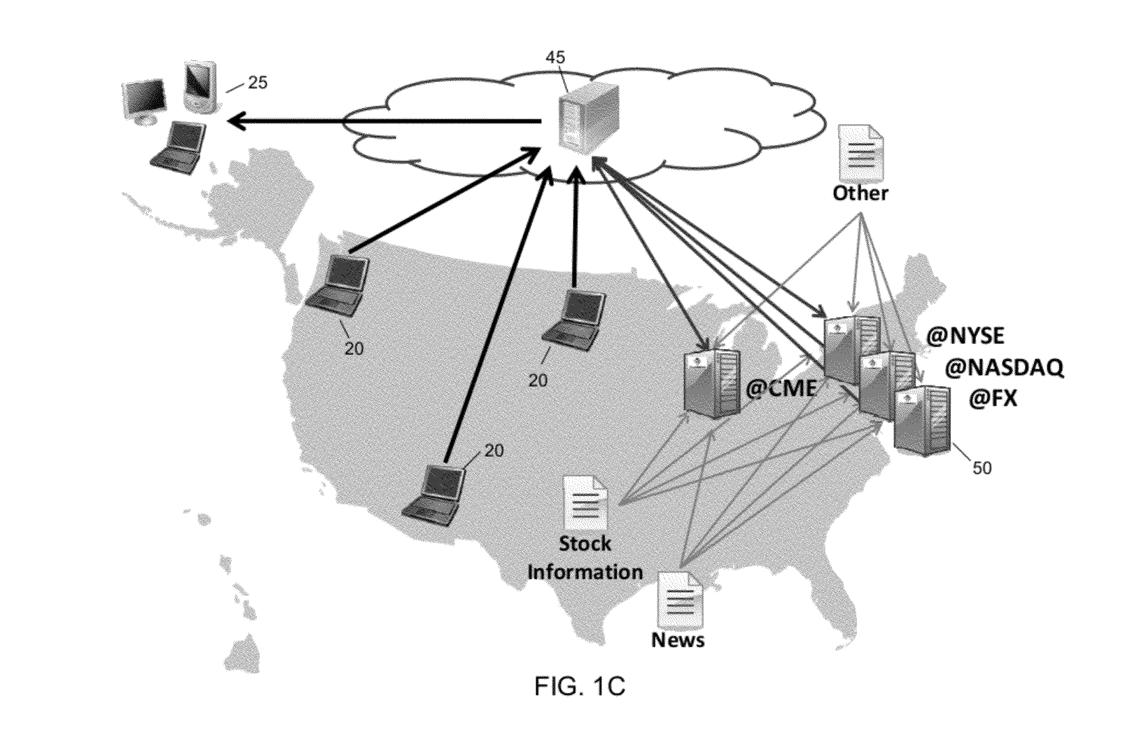

Turning now to FIG. 1A, one embodiment of cloud computing-based system suitable for implementing features of the invention is depicted. In one embodiment, after a client creates an algorithm, the algorithm is stored in a cloud-based system and is run constantly on the service provider's servers. The system or platform may be divided into two sections, a front end 10 and a back end 15. The front end side 15 is client facing, i.e. personal computers 20, mobile devices 25, and other client 20 or browser-based approaches. The back end 15 is the cloud or network-based portion of the system and includes multiple data centers 30 at various locations around the world. In one embodiment, widgets are used on the client-side to build event or trading algorithms such by using an application or a browser on a given client 20.

The data centers 30, according to one embodiment include multiple servers and associated data storage systems. In one embodiment, each server location is selected relative to and linked to multiple financial institutions within the area. In one embodiment, server locations are selected to be as proximal to the locations of an exchange venue 40 as possible. Such an implementation allows the shortest distance or other suitable distance between the communications of the servers, and therefore minimizes latency.

In one embodiment, a fast and efficient server or plurality of servers is used. In addition, given the nature of trades and the valuable nature of the algorithms created using the platform described herein, the server also includes security features and operates in a cost efficient manner. One suitable server may include the HF1 server sold by Appro, which provides various features of interest. For example, a suitable server may include the fastest market-available processors. One currently available option, for example may include two, six-core Intel Xeon X5680 processors, or other similarly fast processors. Such processors may provide optimized overclocking capabilities in processing power. In general, a high performance computing server is suited for high frequency electronic trading according to embodiments of the invention. In one embodiment, a given server is configured to be highly scalable. With hot-swap ability, it is possible replace or upgrade server components without shutting down the trading system. Alternatively, one embodiment of the invention may be implemented on co-located, or proximity hosting services, such as Equinix.

FIG. 1B depicts an exemplary grid system 42 for each data center is illustrated in which a client computer may connect to a control node 45, which in turn connects to multiple application servers 50, database storage 55 and a back-end computer network 60. In one embodiment, for each data center location, all of the servers 50 used by the system are networked to form a grid or other network configuration. As a result all networked servers are able to access and use the resources of every other server on the network. This system uses load sharing and balancing across multiple servers to complete tasks more efficiently and quickly. Usually one server is devoted to one particular application; however, there are times when a particular server is not running at its full capacity and the others are, creating inefficiencies in computing resources.

In one embodiment, for each data center's grid system, various hardware elements may be included. Specifically, these may include at least one server that handles all the administrative duties of the gird (a control node 45). This control node 45 prioritizes and schedules tasks across the network grid. It also monitors the system and makes sure that the system does not become overloaded. In one embodiment, the control node 45 distributes workload across the network of servers 50. Suitable software such as special grid computing network software may also be included with each server. In addition, specialized middleware may also be used. For example, in one embodiment, the purpose of middleware is to allow different servers to run a process or application across the entire network.

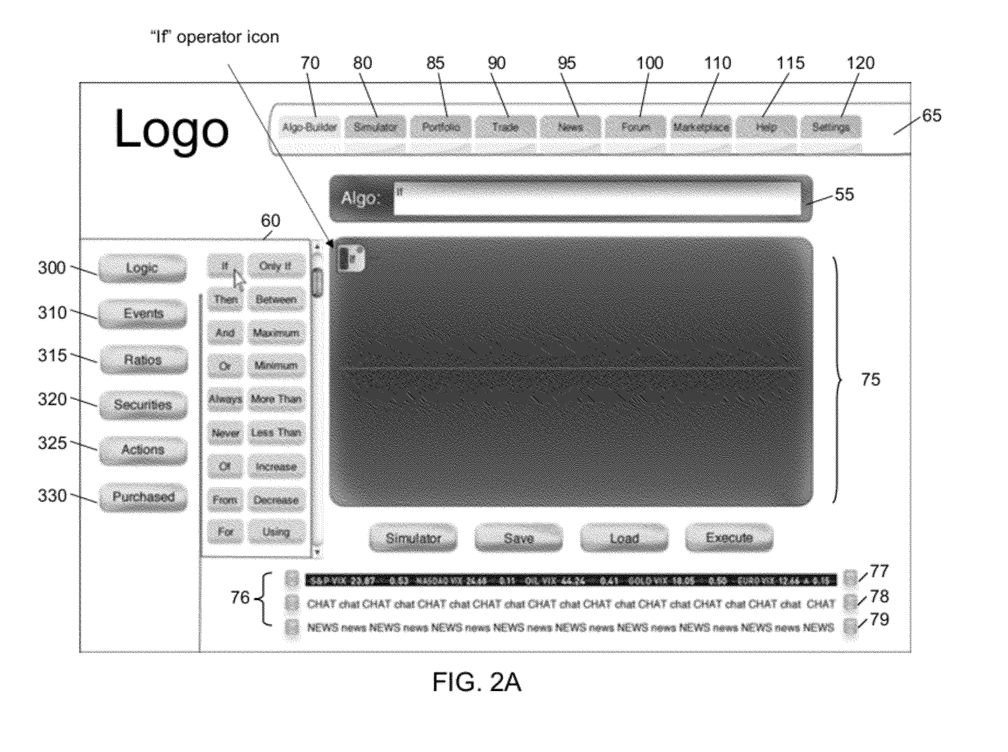

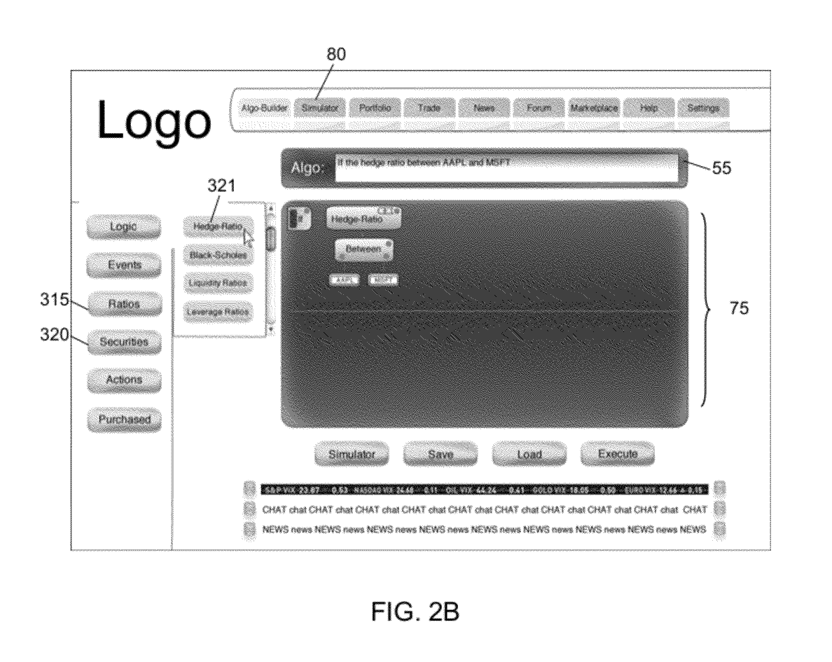

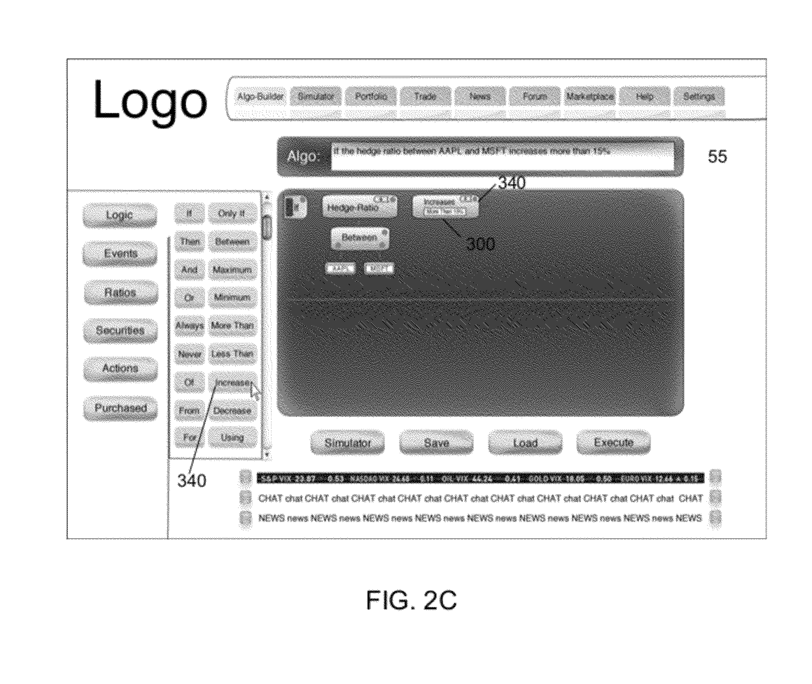

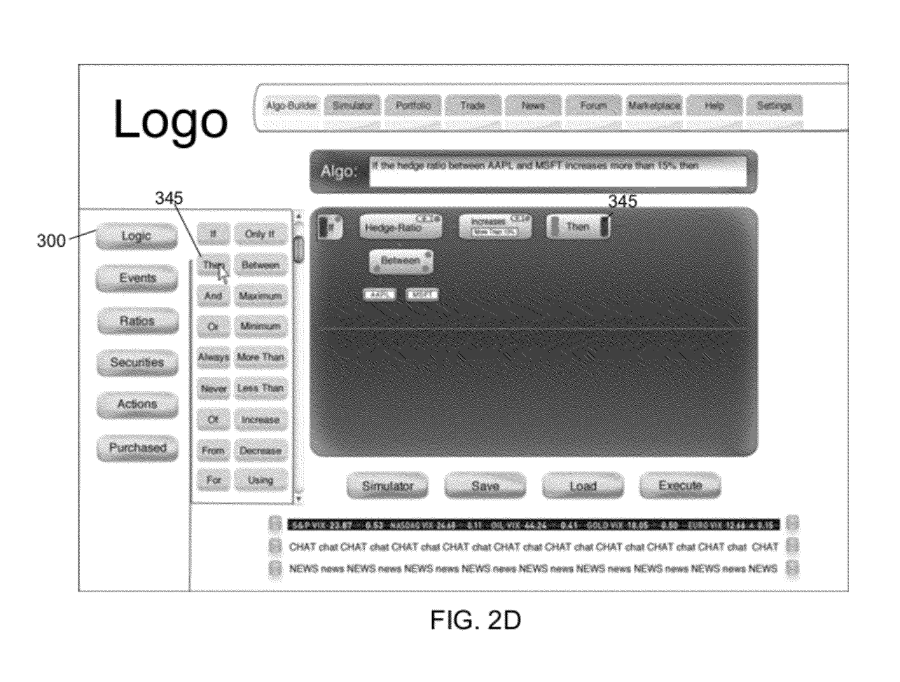

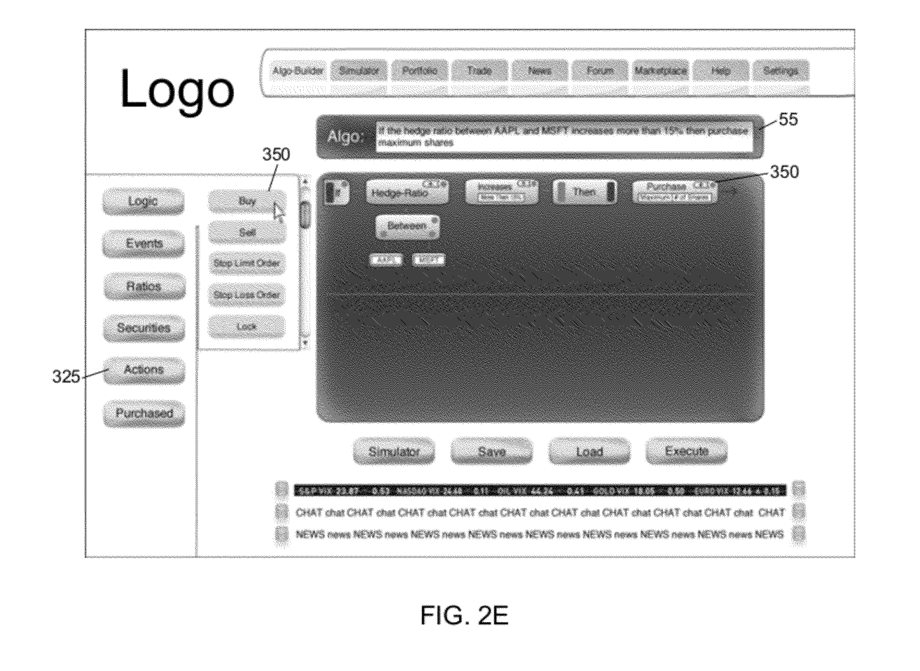

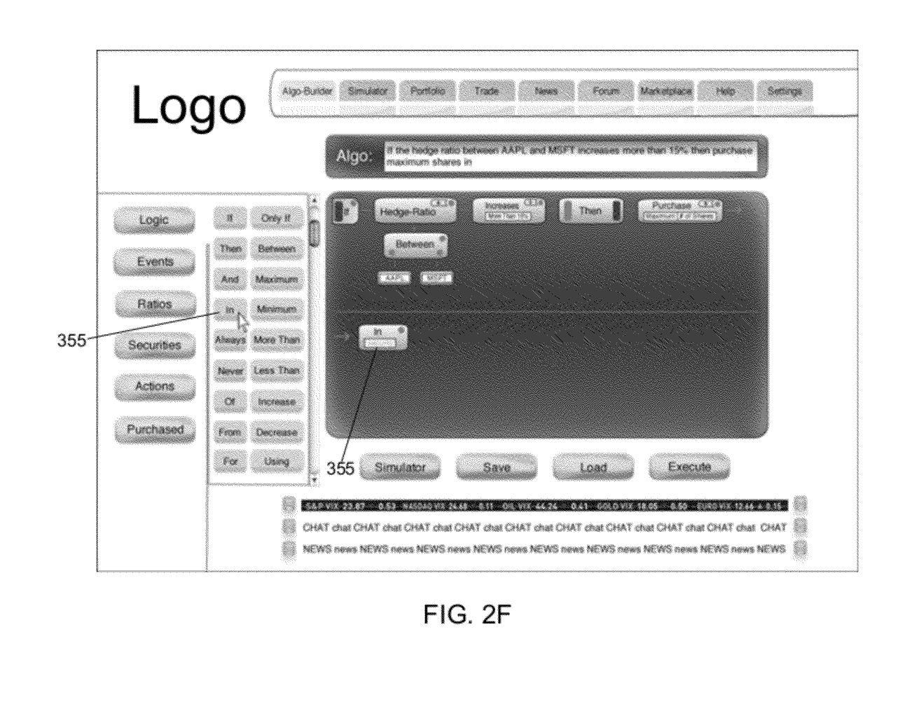

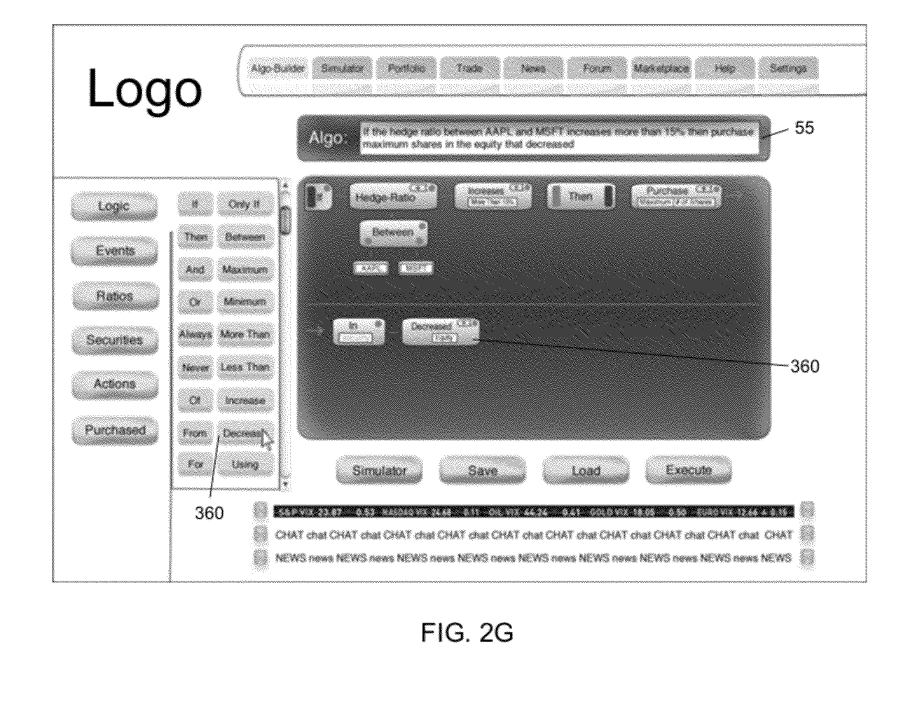

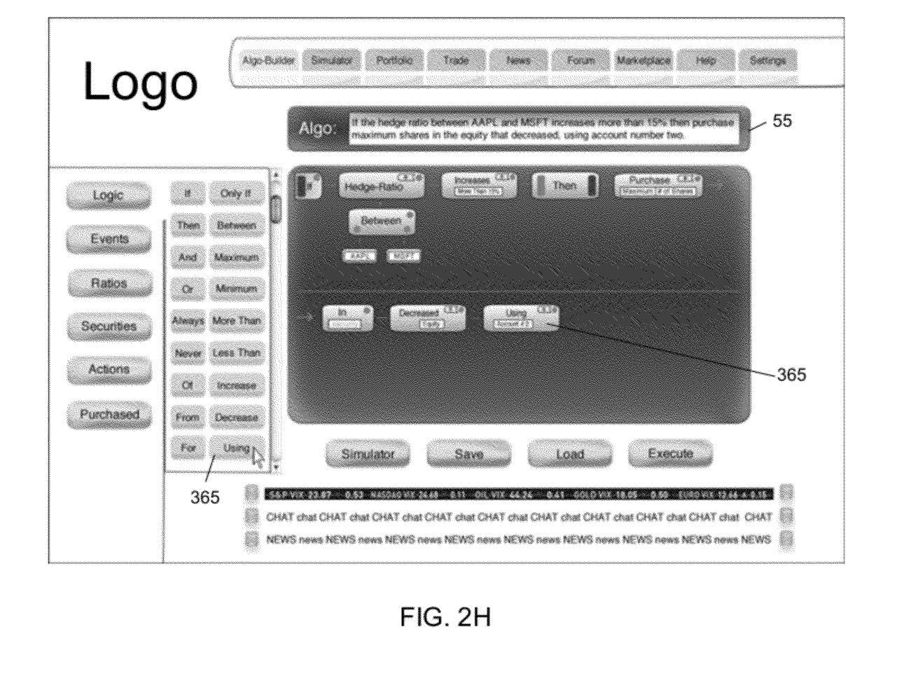

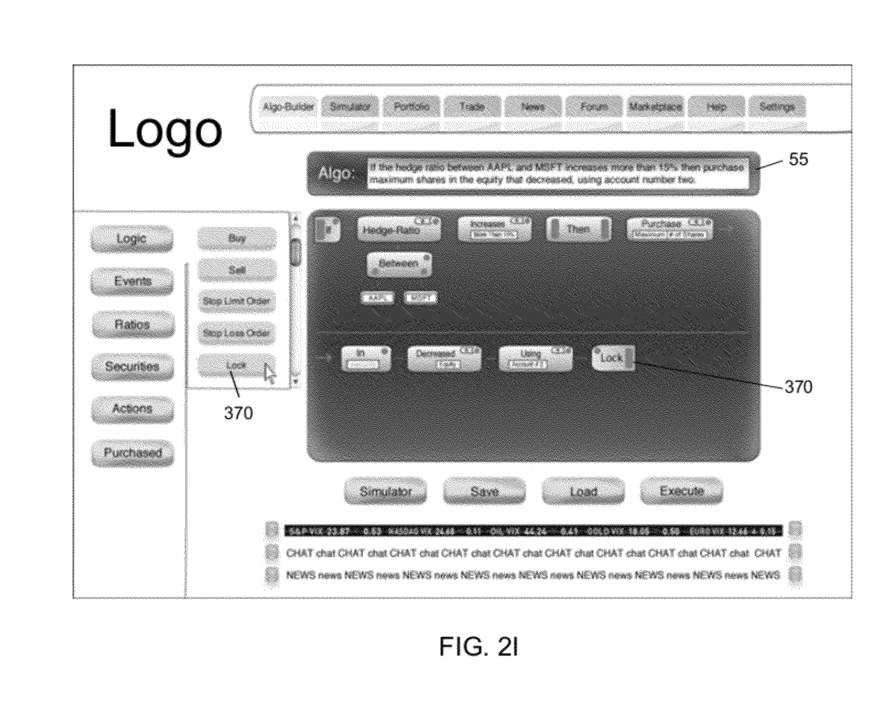

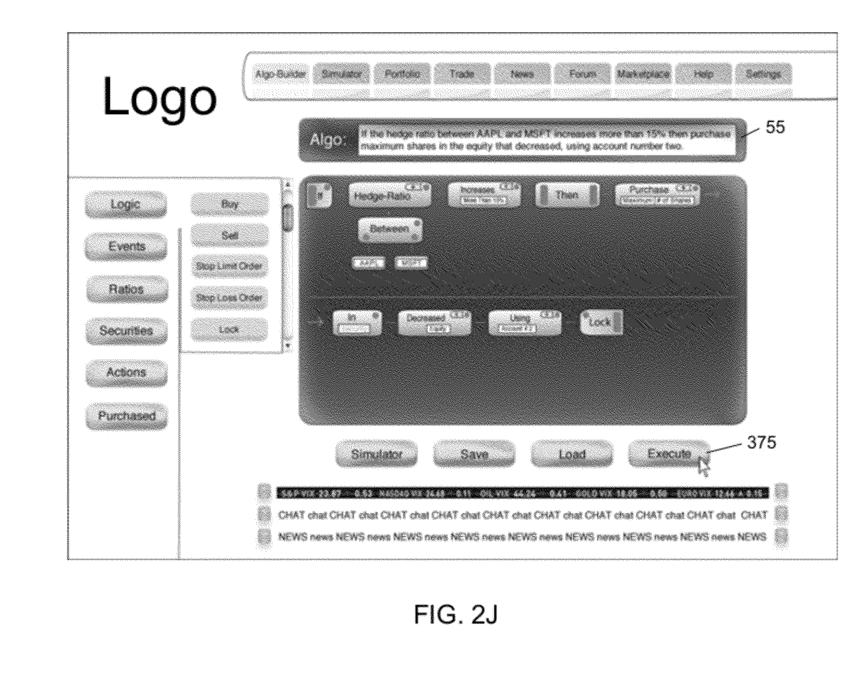

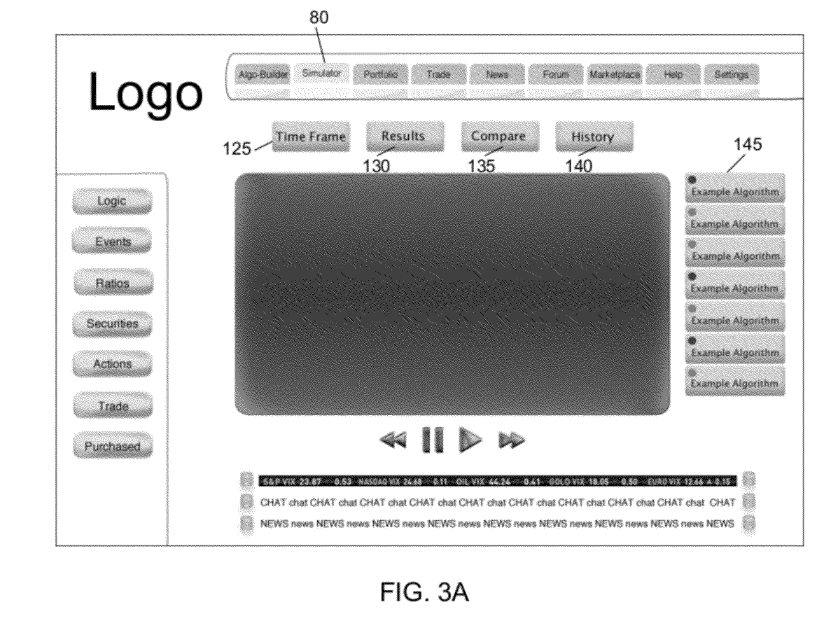

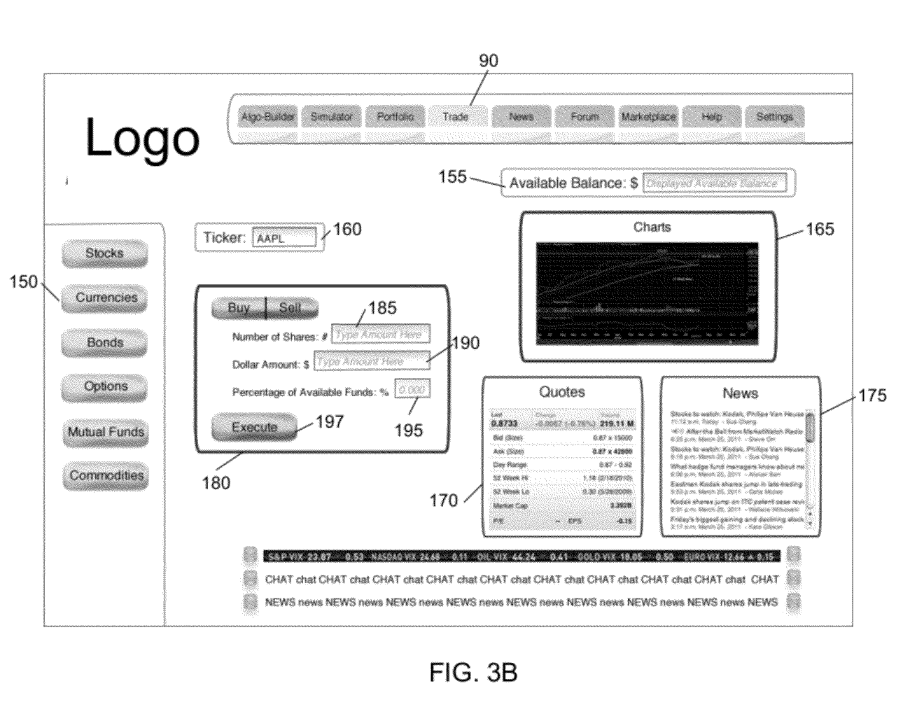

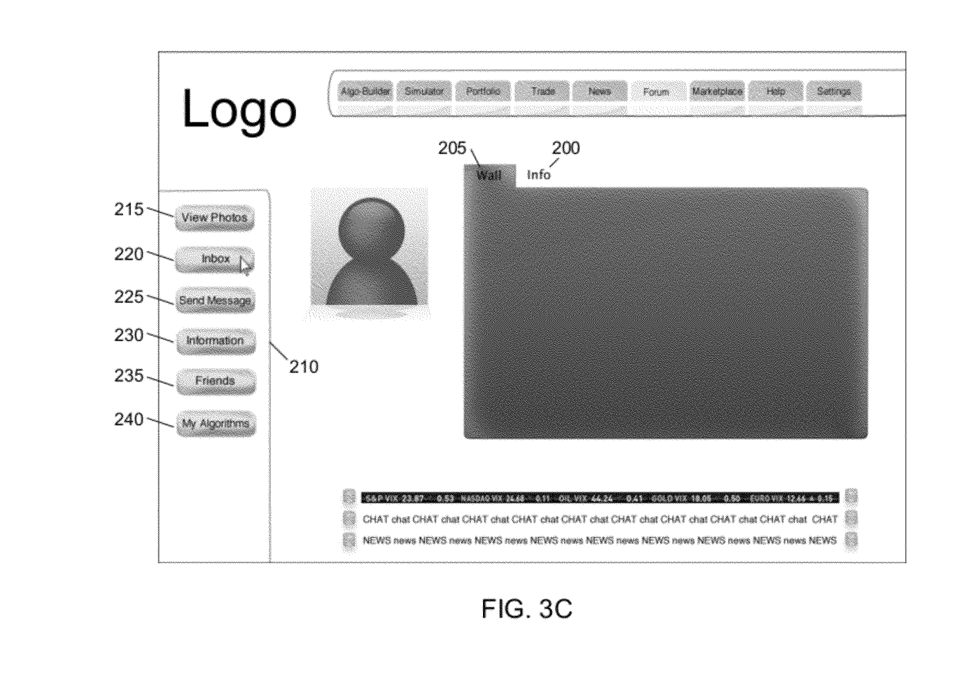

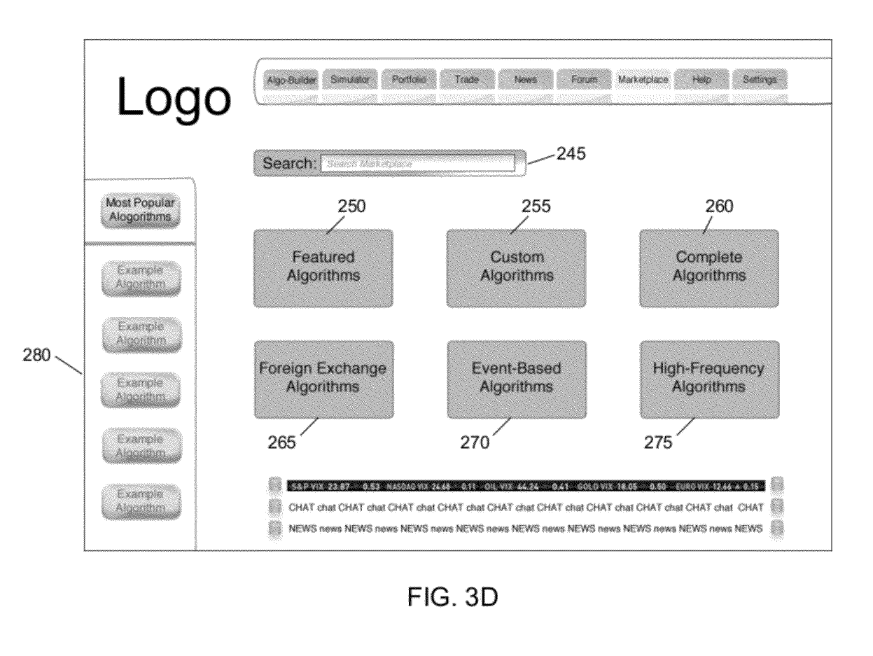

In one embodiment, a cloud-based exchange system 61, as shown in FIG. 1C directs user selected or constructed algorithms to proper execution server(s) based on the security being traded. As shown, various client computers 20 or mobile devices 25 are used generate algorithms using a browser or a software application installed on the device. The algorithm status for a given trading algorithm generated using one of the interfaces described herein can be viewed and managed from various users or clients such as computers 20 and mobile devices 25. The client computers communicate with a control node 45. In turn, the control node 45 routes data and information to proximity servers 50 and back to the browser or client application. Examples of interface screens for such a client application are discussed below with respect to FIGS. 2A-2J and FIGS. 3A-3D.

Various steps of a method of the invention can be implemented with the system of FIG. 1C. In one embodiment, as an initial step, algorithms are designed on a network-based application via personal computer and then sent to the control node 45. In one embodiment, the control node 45 routes a constructed trading algorithm to a suitable execution server. In addition, as another step trading algorithms run in the cloud on co-located and proximity hosted execution servers 50. While running on these servers 50, the trading algorithms, which are mapped to individual traders, receive input from real-time data streams.

Each data center may also be connected to each other so as to form a private cloud network. This private cloud network includes one or more servers and functions as a back end operating environment for an overall trading and trading algorithm creating and implementing platform. A fixed IP address router may be used in one embodiment to configure such a backend. Typically, a router has dynamic IP address upon connection to the internet. However, one embodiment described herein advantageously uses a fixed IP address router to ensure reliable and successful communications between each data center. With the router installed, a private network, which is invisible from the internet through the use of Network Address Translation (NAT) may be created with a static IP address, such that each data center knows precisely how and where to communicate with the other data centers.

In one embodiment, the system includes a plurality of data centers at different locations in the world. For example, a user in Asia may request a service from a domain name or other portal in communication with the platform in accordance with an embodiment of the invention. The Domain Name System (DNS) acts as a phone book and translates hostnames to IP addresses and directs the user to a cluster of servers that are geographically closest to the user so the site may be accessed rapidly. This will connect the user to an embodiment of the network-based trading platform described herein. The user inputs its own trading algorithms on the systems and platforms described herein. In one example, the control node may determine that the initiated trading algorithm involves US stocks in New York; the node may then route the information to a data center in New York or New Jersey and the algorithm is stored and continuously run locally on that data center's servers.

In one embodiment, a first server is dedicated to administrative operations as a control node. In addition, a second and a third server may also be included such that the second server executes algorithms while the third server is used for executing trades. Further, depending on the number of clients, additional servers may be added to the underlying grid system and other features resulting in a highly scalable architecture. In addition, a Storage Area Network (SAN) may also be included in one more embodiments. A given SAN may include a high-speed subnetwork of shared storage devices. In one embodiment, the SAN controls and connects the storage devices with respect to all of the servers. As more storage devices are added to the SAN, they will also be visible to any server in the network. Client-generated algorithms and databases relevant to the algorithms and client accounts may be stored through the SANs. Also, account history and trading history for high volume trades may also be so stored for future statistical analysis and date mining for use in developing new trading algorithms.

By having the algorithms run in close proximity to the exchange venue the number of switches, routers, cables, and distance the data has to travel is reduced. In addition, one embodiment may include parallel computing on the servers, similarly to those commonly used by supercomputers to perform large calculations. Thus, one feature of one embodiment is to enable high frequency trading with high speed trade execution to increase the likelihood of a profitable trade while also expeditiously mitigating losses when necessary.

Exemplary representations of the user interfaces of an embodiment in which trading algorithms or routines can be constructed are shown in FIGS. 2A-2J. In one embodiment, users may create simple or complex algorithms using a drag and drop visual programming interface. As an example, starting at FIG. 2A and continuing on through the figures in order until FIG. 2J show a stock trading algorithm or routine that is made up of a plurality of drag and drop widgets or components. Widgets can be used as the building blocks to graphically program an algorithm, using a web browser or other suitable platform or engine. Each widget can map to an element or component of an algorithm. Widgets can viewed when in an active area of an interface and when dragged and dropped. Each component widget can be dragged and dropped within an active area as described herein. The widgets can be configured to have individual interface rules such that they are designed to snap to other widgets that maintain a proper syntax for a given event or trading algorithm to remain executable and otherwise valid.

Translation from widget form to actual code (JAVA, C++, or other suitable languages) can be performed on the server side. In one embodiment, following the transformation from sequence of widgets to code for a given algorithm, once generated the code form of the algorithm can be routed to the proper device or storage location. For example, the code form of the algorithm assembled as widgets in FIGS. 2A-2J can be transferred to a simulation server, execution server, or other device of interest. In one embodiment, execution of the code form can be performed using an API configured to be compatible with the code form of the algorithm. The API's can be generated for all existing commercial computer-based brokers.

This sequence of user interfaces in FIGS. 2A-2J reveals various user actions that allow for a routine or trading algorithm to be constructed. Once constructed it may be sold, executed, or simulated. When it is executing, it is transferred to a cloud-based server for persistent execution and receipt of real time data streams upon which it can operate and initiate trades in one embodiment.

FIG. 2A shows a navigation menu bar 65 in the top portion of the user interface embodiment. This navigation menu includes a plurality of user clickable or executable buttons or other inputs. The graphical interface can have any suitable Logo as shown in the top left portion of the interface to indicate the provider of the service. This can be co-branded by the provider of the software or offered as a private label brand with the logo of the financial service provider shown as the Logo.

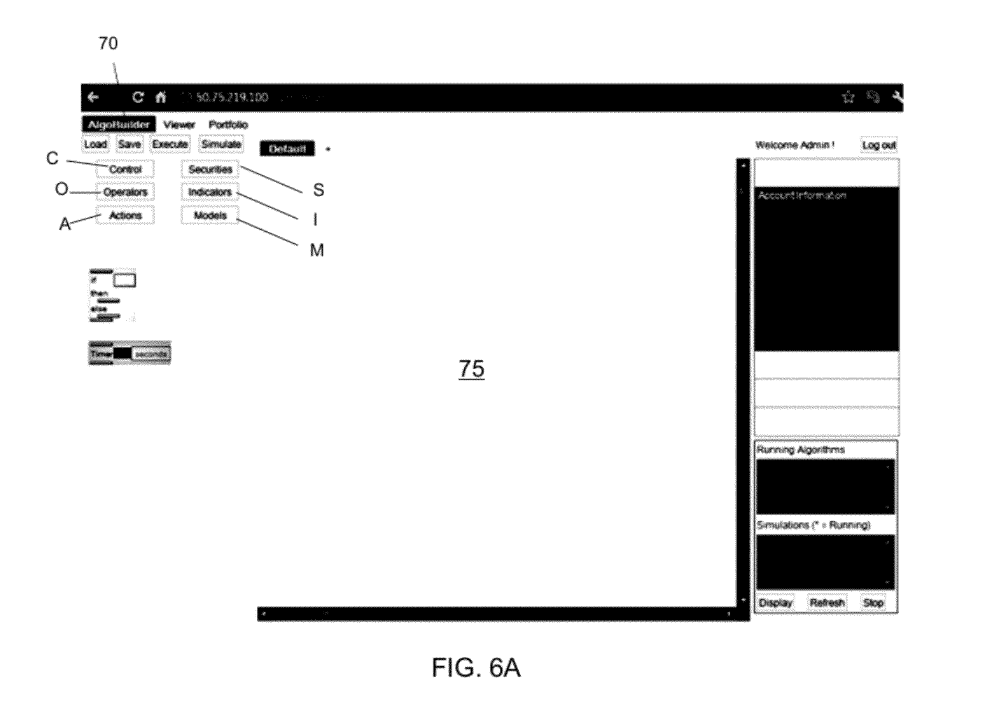

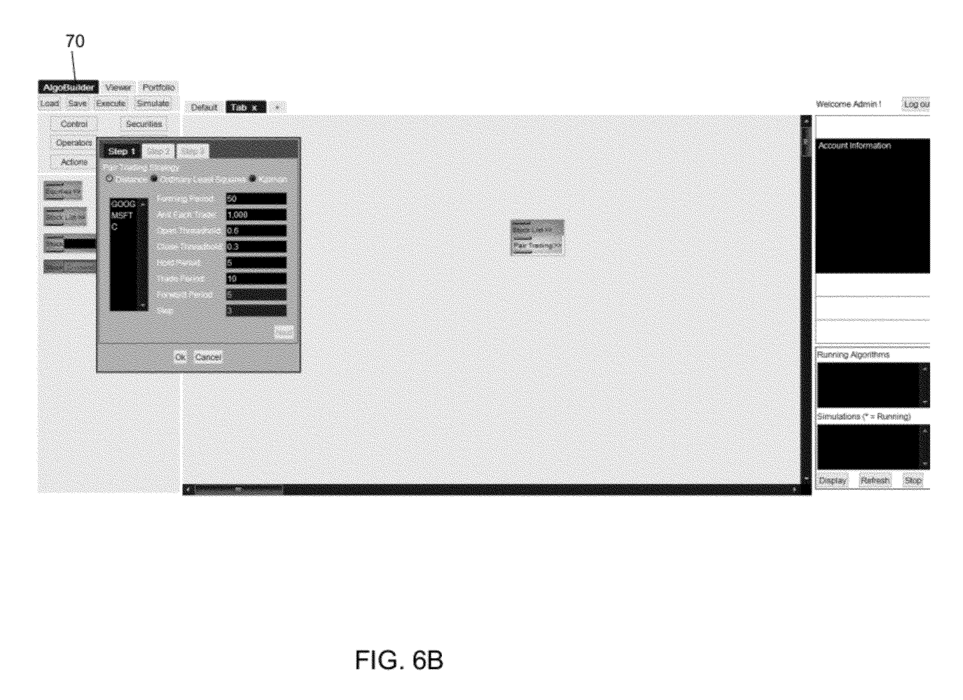

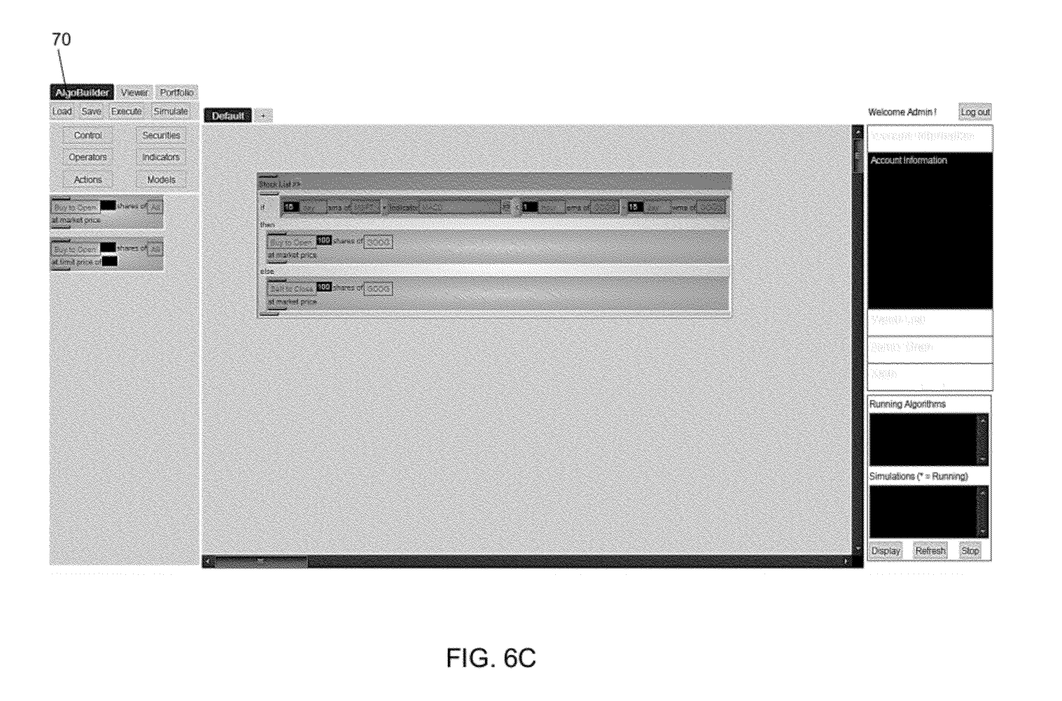

In one embodiment, a portion of the interface screen also includes an input box 55 for manually entering algorithms pursuant to a simplified textual algorithm scheme. The box is labeled “Algo:” as shown. Alternatively, the box may display a sequence of descriptors, conditional states, or pseudo-code as widgets are linked together to build a given trading algorithm. This also translates the selection of widgets from which the algorithms is built. Thus, the “meaning” of the algorithm as the user creates it with the visual drag and drop modules are displayed as shown. In FIG. 2A, the first element shown in the box is the conditional element, “If,” chosen from a list of operators 60, which starts the stock trading algorithm. FIG. 6A shows an alternative embodiment of an AlgoBuilder user interface.

As shown, in FIGS. 2A-2J, in the menu bar 65 portion of the screen there are interface buttons labeled Algo-builder 70, Simulator 80, Portfolio 85, Trade 90, News 95, Forum 100, Marketplace 110, Help 115 and Settings 120. Each of these graphic user interfaces, pages or screens is discussed below. As shown, in the top left tab 70 of the menu bar 65 of FIG. 2A-2J, the interface screen or window that allows algorithms or routines to be constructed from graphical representations or widgets is referred to as the algorithm builder (“Algo-builder” or “AlgoBuilder”) in one embodiment. Thus, the subsequent building of an algorithm as shown in FIGS. 2A-2J takes place within the algorithm builder interface. The center portion 75 of the interface is the active region where widgets corresponding to components of the algorithm are dragged, dropped, ordered, and connected to each other. The interface also includes a data bar 76 located at the bottom of the display that may include automatically updateable features such as a stock ticker 77, chat stream or feed 78, or news feed 79.

The simulator interface 80 allows the user to run their algorithms under historical conditions or preset them to run in the future. This allows the user to test if the design or strategy is adequate. A simulation example is shown in FIG. 3A. Once an algorithm is defined by the user, as described below, the user may run a simulation of the defined algorithm to determine how the platform may respond. The user may view or enact a variety of features to further analyze the results of the simulation. These additional constraints or criteria may be defined by a row of clickable buttons located above the active area. According to one embodiment, as shown in FIG. 3A exemplary functions include Time Frame 125, Results 130, Compare 135 and History 140. A list of previously run algorithms 145 may run down the side of the active area allowing the user easy access to those simulated algorithms.

In turn, with respect to the portfolio interface 85, this interface allows users to view their trading accounts, as well as statistics and breakdowns of their different algorithms. Examples may include profit and losses for each day they have been run.

The trade interface 90 allows the user to execute a manual trade as shown in FIG. 3B. The trade feature is included as a convenience so the users will not have to switch between applications. The trade interface includes several features to facilitate the trading of an asset electronically. A menu of asset types 150 is displayed at the left of the display indicating the available categories of assets that can be traded or researched. An available balance field 155 details the amount of money remaining in the user's trading account. A Ticker field 160 includes a text-input box allowing the user to enter and retrieve data for the entered ticker symbol or abbreviation. The data retrieved for the particular ticker symbol may be displayed in the form of charts 165, Quotes, 170 or News, 175. An action box 180 includes operators and fields that allow the user to buy or sell a given asset. The input fields include a number of shares 185, the dollar amount 190 or a percentage of the available funds 195 listed in the available balance field 155. Once the necessary inputs are entered the user may execute the trade by clicking the “Execute” button 197.

The News interface 95 allows readers to view news and look up securities. The news sources may be customizable and include all the major sources. The forum interface 100 is a portal to a social network interface relating to trading and algorithmic trading. An example forum interface is shown in FIG. 3C. In one embodiment, the platform allows users to create an information profile 200 and communicate with each other. Message boards or walls 205 where people may post questions and respond to them are also within the scope of the invention. A menu bar 210 to the right of the screen may include various functions associated with a social networking environment, such as, viewing photos 215, inbox 220, send message 225, information/profile 230, friends list 235, and a listing of the user's stored algorithms 240.

The interface also includes additional features relating to trading algorithms or routines such as a marketplace. An exemplary marketplace interface is shown in FIG. 3D. The marketplace interface is an automated marketplace that facilitates the sale, rental or purchase of algorithms designed by users. In one embodiment, the invention includes a market in which users may trade, rent, sell or otherwise monetize trading algorithms they have authored. This may be in the form of a complete algorithm, components of an algorithm, or they may sell their service to build a custom algorithm. A search box 245 allows a user to search the marketplace for algorithms or other data associated with a desired algorithm. The market place also displays the various categories of available algorithms, including, for example, Featured Algorithms 250, Custom Algorithms 255, Complete Algorithms 260, Foreign Exchange Algorithms 265, Event-Based Algorithms 270, or High-Frequency Algorithms 275. An algorithm bar 280 located to the left of the display may include quick-link buttons to recall predefined sets of algorithms, such as Most Popular algorithms, or others.

The help interfaces 115 include tutorials on all the functions of the software including use of the interface and other technical guidance. In one embodiment, it includes an online chat customer service area. The settings interface 120 includes customizable settings and preferences for the application. It can control the content on the scrolling section at bottom of one or more interface windows.

As described above, embodiments of the invention include one or more software applications that collect user inputs and transform them into icon movement and linking. By moving and linking widgets, a routine or algorithm for low latency trading is created from graphical building blocks. In addition, the widgets may also include other previously generated or historic algorithms of interest as well as operators, logic, variables, and events of interest.

As shown in FIGS. 2A-2J, embodiments of the trading algorithm or routine builder include a plurality of criteria categories. The criteria categories are used to create steps, decision points and thresholds for a customized trading algorithm. In one embodiment, these features or criteria are responsive to user selection. Specific categories or criteria that may be used include, without limitation, Logic 300, Events 310, Ratios 315, Securities 320, Actions 325, Purchased 330 and various other selectable menus or features. In one embodiment, each element in a set of categories is graphically representable as a widget. Using an alternate naming convention and some different categories are shown in the embodiment of FIG. 6A. In FIG. 6A, the categories shown on the high level interface screen are Control C, Securities S, Operators O, Indicators I, Actions A, and Models M. Each of the foregoing categories of operators and other categories can include several operators that can be selected after choosing the operator category. These are shown on the left side of the interface screens. The categories of criteria can be summarized as follows:

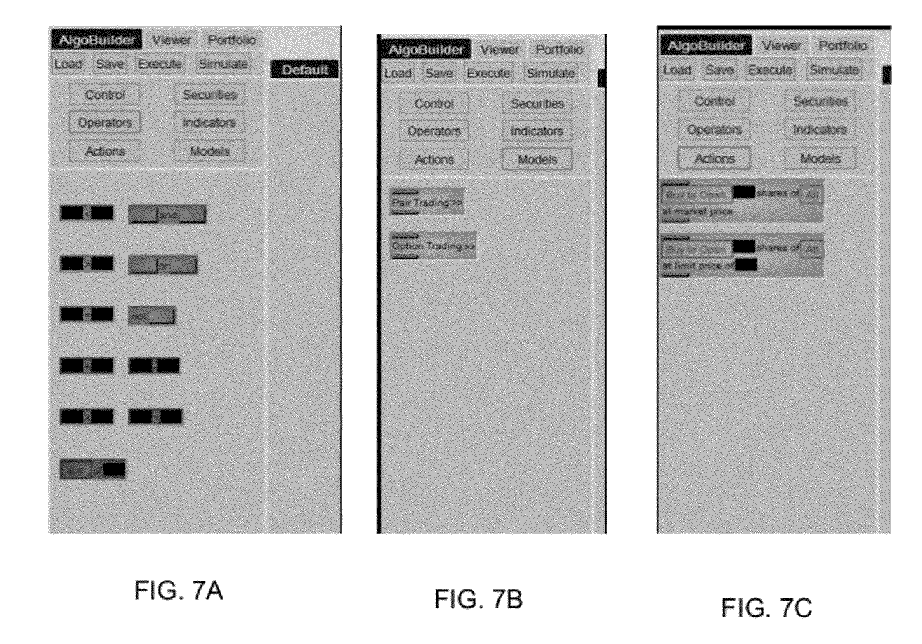

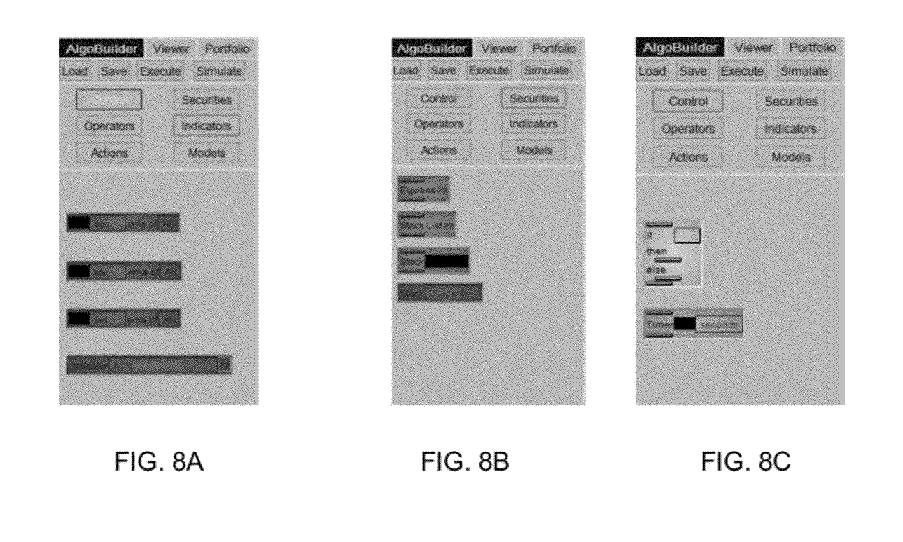

Logic: When a user clicks on the Logic 300 button they access all the logic widgets 335 that represent the fundamental components of the user's algorithms. A user may drag and drop such logic widgets into the active area as shown to build a trading algorithm. In the interface shown in FIG. 2A, the “If” operator was selected from the Logic subset and dragged into the active area. The plain language representing the action is automatically entered into the “Algo” field 55. In one embodiment, the Control interface C as shown in FIGS. 6A and 8C includes certain logic such as a default if ______, then ______, else ______ structure that can be used to build many algorithms. In addition, the Operator interface O as shown in FIGS. 6A and 7A shows various inequalities, addition, subtraction, and other mathematical operators that can be used to build a given trading or event algorithm.

Events: When a user clicks on the Events button access to multiple event functions which will allow them to execute trades based on news, online, and technical data sources. Examples would be trading strategies that rely on screeners or searching bots. Various events of interest such as war, earthquake, rally, and other news items may be made available as drag and droppable events of interest with respect to which an algorithm or buy/sell trigger may be implemented.

Ratios: This section includes all of the mathematical functions that are used in algorithm creation. Examples are: VWAP, Time Weighted Average Price (TWAP), Black-Scholes, Liquidity Ratio, Leverage Ratio or Hedge Ratio. Various ratios may include a drop down menu such that various numerical parameters may be adjusted with respect to a ratio icon and other widgets used to build an algorithm. In the illustrative algorithm creation step shown in FIG. 2B, a hedge-ratio 321 was dragged and dropped into the active area 75. The user may then select two assets to use in the hedge ratio. In one embodiment, the user may select available assets from the Securities category 320 described below, or the user may type the ticker symbol into the Algo field 55 or directly into the widgets generated in the active area. In the illustrative example a hedge-ratio is set up between “AAPL” and “MSFT.” Again, the Algo field 55 is updated to reflect the drag and dropped operators.

Securities: This section includes all the types of securities that may be traded using the platform. Examples include, without limitation, Stocks, Bonds, Currencies, Options, etc. In one embodiment, the Securities interface S as shown in FIGS. 6A and 8B includes certain categories or default lists such as equities, stock list, stock and divided.

Actions: This section includes all the execution commands for the algorithm. Examples are: Buy, Sell, Short, etc. In one embodiment, the Action interface A as shown in FIGS. 6A and 7C shows various actions such as buy at X or sell at Y that can be used to build a given trading or event algorithm. These actions can be the second event that occurs in response to a first event that is part of an algorithm that results in a trade being executed.

Purchased: This section includes all algorithms and components purchased or rented from the Marketplace.

Models: As shown in FIGS. 6A and 7B, the model interface M can include various pre-built or standard algorithms for use in using “as-is” or as parts of new algorithms. Pair trading is shown as one model in FIG. 7B as an option and in FIG. 6B as a multi-tabbed interface for using such a model. Another model identified in FIG. 7B is option trading. Various models and trading methods can be made available using the model interface.

Indicators: As shown in FIGS. 6A and 8A, the indicator interface is configured to list various different financial indicators such as moving averages, MACD, ATR, etc. that can be used to build algorithms.

As shown in FIGS. 2A-2J, a series of widgets are dragged, dropped, and linked to build an algorithm. Following the steps described in connection with FIGS. 2A and 2B, FIG. 2C depicts the addition of another Logic step of “Increase” 340 in which the user may set a threshold minimum increase to the Hedge-Ratio defined in previous steps. In the illustrative example, the Increase logic step is set at “more than 15%.” The Algo field 55 is updated to reflect that the algorithm as defined reads: If the hedge ration between AAPL and MSFT increases more than 15%.” FIG. 2D depicts a further change to the algorithm by adding the “Then” 345 operator from the Logic subset 300.

FIG. 2E depicts the addition of the action operator “Purchase” 350 from the Actions operator category 325. The Purchase 350 action requires an input of the maximum number of shares to purchase. FIG. 2F depicts the next step of the algorithm added with the inclusion of the “In” 355 operator followed by the “Decreased” operator 360 added and shown in FIG. 2G. The “Decreased” operator 360 takes the input of the asset to be purchased if the previous conditions of the algorithm are satisfied. In the illustrative example of FIG. 2G, the algorithm would initiate a purchase a maximum number of shares of the equity from the Hedge Ratio that decreased (causing the Hedge Ratio to increase more than the 15% threshold.) FIG. 2H includes the identification of the user account from which the purchase will be made by adding the “Using” operator 365 and inputting the desired account name or information. FIG. 2I depicts the conclusion of the algorithm construction by adding the “Lock” operator 370 from the Actions category, indicating the algorithm is complete and locked.

FIG. 2J depicts the completed algorithm with the active area defining the drag-and-drop operators which define the steps of the designed algorithm. Before any action is taken the user must click the “Execute” button 375 to initiate the platform' processing of the algorithm.

Once activated, this algorithm may be processed using the servers and high speed network topologies described herein. Thus, this constructed trading algorithm can run in a cloud computing environment until such time as the trader controlling it, changes it, pauses it, or otherwise stops it. Specifically, in FIG. 2J, the final algorithm is “If the hedge fund ration between Apple and Microsoft increases more than 15% the purchase maximum shares in the equity that decreased using account number two.” The ability to build such an algorithm using widgets associated with logic, operators, tradable companies or commodities, offers numerous advantages and allows new and interesting trading techniques to be developed and tested on the fly in a simulated environment before using a real account and being exposed to real risk as described above.

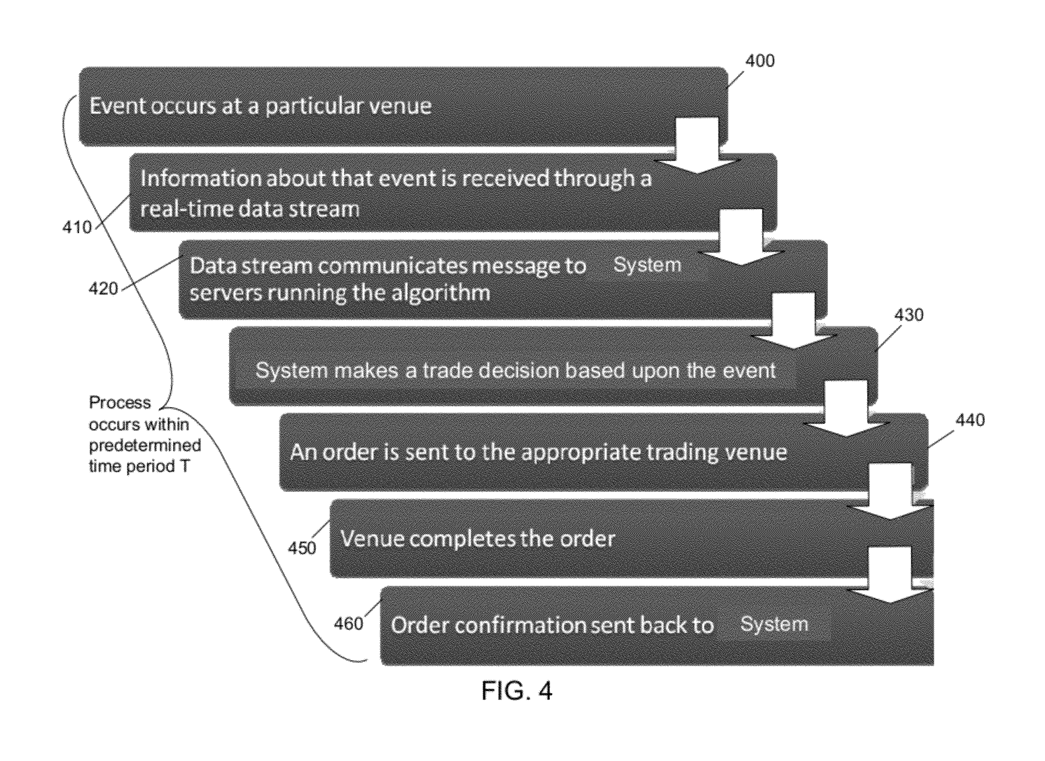

According to another embodiment, as depicted in FIG. 4, the trading platform includes a method of executing algorithms in the cloud using real-time data streams to execute trades autonomously. According to one embodiment of the method, an event occurs at a particular venue 400 followed by information about that particular event being received through a real-time data stream 410. In one embodiment, the event can be a natural disaster, an election result, or other news events which the system can be configured to recognize and trigger upon. Real time data streams used by institutional investors throughout the world can be a source of such events.

In one embodiment, the data stream communicates the information or message to system servers running the defined algorithm 420. The system then, based on the information, makes a trade decision 430 and, if appropriate, an order is sent to the appropriate trading venue 440, where the trade is executed 450 and a trade confirmation is sent back to the system 460. The duration of the entire process from detection of the event to confirmation of the execution of the trade occurs within a predetermined time period T. In one embodiment, the time period T may can range from greater than about 0 to about 10 milliseconds. In one embodiment, the time period T may can range from greater than about 0 to about 5 milliseconds. In one embodiment, the time period T may can range from about 0.1 milliseconds to about 4 milliseconds. In one embodiment, one or more algorithms are used to optimized networking and data processing in a cloud computing embodiment such that real-time data streams can be used as inputs that one or more system and method embodiments can execute trades autonomously.

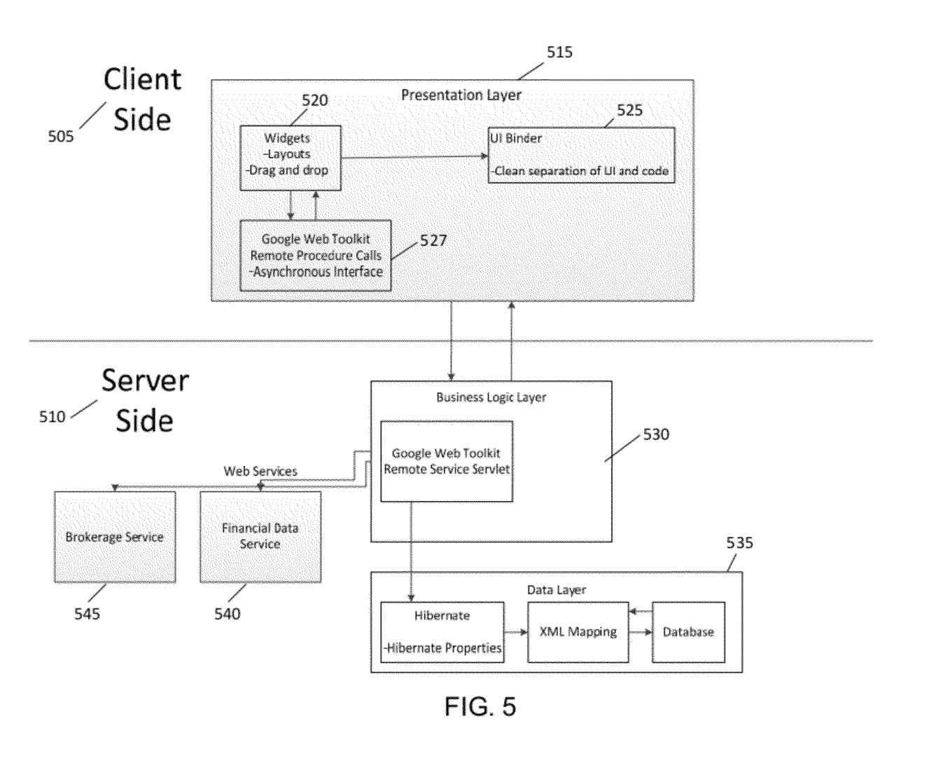

Turning now to FIG. 5, a system architecture of one software-based embodiment of the invention is depicted. As described above, the platform may be implemented across a client-side 505 and server-side 510 computer architecture. The client-side may include a presentation layer 515 including a graphical interface through which the user interacts with the trading platform. The presentation layer may include various widgets 520 that define layout and drag-and-drop capabilities. The presentation layer also may include a user-interface binder 525 which provides a separation between the user-interface and the software code. A Web-toolkit 527, such as the Google Web Toolkit, may be used to implement an asynchronous interface using remote procedure calls.

The server side 510 may include a business logic layer 530 which sends and receives data and from the client-side application. The business logic layer may use a web toolkit to implement a remote service servlet. The business logic layer communicates with a data layer 535 which includes and provides hibernation, xml-mapping and database capabilities to the server-side platform. In one embodiment, the reference to hibernate or hibernation refers to a object-relational mapping library or framework. The business logic layer also communicates with various web services, such as financial data services 540 or brokerage services 545 to execute, monitor and otherwise interact with the trading markets.

In the description, the invention is discussed in the context of security and asset trading; however, these embodiments are not intended to be limiting and those skilled in the art will appreciate that the invention may also be used for various types of financial simulations and models.

The aspects, embodiments, features, and examples of the invention are to be considered illustrative in all respects and are not intended to limit the invention, the scope of which is defined only by the claims. Other embodiments, modifications, and usages will be apparent to those skilled in the art without departing from the spirit and scope of the claimed invention.

The use of headings and sections in the application is not meant to limit the invention; each section may apply to any aspect, embodiment, or feature of the invention.

Throughout the application, where systems or platforms are described as having, including, or comprising specific components, or where processes are described as having, including or comprising specific process steps, it is contemplated that systems or platforms of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component may be any one of the recited elements or components and may be selected from a group consisting of two or more of the recited elements or components. Further, it should be understood that elements and/or features of a composition, an apparatus, or a method described herein may be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the invention as if each value were specifically enumerated herein. In addition, smaller ranges between and including the upper and lower limits of a given range are contemplated and encompassed within the invention. The listing of exemplary values or ranges is not a disclaimer of other values or ranges between and including the upper and lower limits of a given range

### Non-Limiting Software Features and Embodiments for Implementing Graphic User Interface, Trading Algorithm Construction Set, and Related Embodiments of the Invention

The following description is intended to provide an overview of device hardware and other operating components suitable for performing the methods of the invention described herein. This description is not intended to limit the applicable environments or the scope of the invention. Similarly, the hardware and other operating components may be suitable as part of the apparatuses described above. The invention can be practiced with other system configurations, including personal computers, multiprocessor systems, microprocessor-based or programmable electronic device, network PCs, phones, laptops, mobile devices, and the like.

Some portions of the detailed description are presented in terms of algorithms and symbolic representations of operations on data bits within a computer memory. These algorithmic descriptions and representations can be used by those skilled in the computer and software related fields. In one embodiment, an algorithm is here, and generally, conceived to be a self-consistent sequence of operations leading to a desired result. The operations performed as methods stops or otherwise described herein are those requiring physical manipulations of physical quantities. Usually, though not necessarily, these quantities take the form of electrical or magnetic signals capable of being stored, transferred, combined, transformed, compared, and otherwise manipulated.

Unless specifically stated otherwise as apparent from the following discussion, it is appreciated that throughout the description, discussions utilizing terms such as “processing” or “computing” or “calculating” or “dragging” “trading” or “verifying” or “routing” “generating” or “determining” “executing” or “displaying” or the like, refer to the action and processes of a computer system, or similar electronic computing device, that manipulates and transforms widgets or data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer.

The algorithms and displays presented herein are not inherently related to any particular computer or other apparatus. Various general purpose systems may be used with programs in accordance with the teachings herein, or it may prove convenient to construct more specialized apparatus to perform the required method steps.

The present invention may be embodied in many different forms, including, but in no way limited to, computer program logic for use with a processor (e.g., a microprocessor, microcontroller, digital signal processor, or general purpose computer), programmable logic for use with a programmable logic device, (e.g., a Field Programmable Gate Array (FPGA) or other PLD), discrete components, integrated circuitry (e.g., an Application Specific Integrated Circuit (ASIC)), or any other means including any combination thereof. In one embodiment of the present invention, some or all of the processing of the user inputs and manipulation of widgets associated or linked with a component of a trading routine or algorithm is implemented as a set of computer program instructions that is converted into a computer executable form, stored as such in a computer readable medium, and executed by a microprocessor under the control of an operating system. In embodiment, user movements and commands are transformed into processor understandable instructions suitable for generating, monitoring, and routing trades related to a security or other asset and other features and embodiments as described above.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, C#, JAVA, or HTML) for use with various operating systems or operating environments. The source code may define and use various data structures and communication messages relating to parsing components of trading algorithms and any of the other features described herein. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies networking technologies, and internetworking technologies. The computer program may be distributed in any form as a removable storage medium with accompanying printed or electronic documentation (e.g., shrink-wrapped software), preloaded with a computer system (e.g., on system ROM or fixed disk), or distributed over a network.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink-wrapped software), preloaded with a computer system (e.g., on system ROM or fixed disk), or distributed from a server or electronic bulletin board over the communication system (e.g., the Internet or World Wide Web).

Various examples of suitable processing modules are discussed below in more detail. As used herein a module refers to software, hardware, or firmware suitable for performing a specific data processing or data transmission task. Typically, in a preferred embodiment a module refers to a software routine, program, or other memory resident application suitable for receiving, transforming, parsing, translating, routing and processing instructions, or various types of data such as algorithmic trading data, logic, conditional statements, events of interest, proximity server commands, exchange venue transactions, and other information of interest.

Computers and computer systems described herein may include operatively associated computer-readable media such as memory for storing software applications used in obtaining, processing, storing and/or communicating data. It may be appreciated that such memory may be internal, external, remote or local with respect to its operatively associated computer or computer system.

Memory may also include any means for storing software or other instructions including, for example and without limitation, a hard disk, an optical disk, floppy disk, DVD (digital versatile disc), CD (compact disc), memory stick, flash memory, ROM (read only memory), RAM (random access memory), DRAM (dynamic random access memory), PROM (programmable ROM), EEPROM (extended erasable PROM), and/or other like computer-readable media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

It may be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It may be appreciated that the examples are intended primarily for purposes of illustration of the invention for those skilled in the art. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

What is claimed is:

1. A computer implemented method of executing an action using a graphical user interface, the method comprising the steps of:
displaying a plurality of drag and droppable widgets within a computer generated graphical environment, each widget associated with a component of an event algorithm;
processing a plurality of the widgets in a predetermined order when such widgets are arranged in a sequence corresponding to steps in the event algorithm;
monitoring data feeds relating to an event of interest, wherein the event of interest is selected from the group comprising stock changes, news events, market events, and regulatory events; and
executing the action within a time period P when conditions defined by the event algorithm are satisfied.

2. The method of claim 1 wherein the time period P is a function of a routing speed of an ultra-low latency network.

3. The method claim 1 wherein the step of displaying is performed within a browser.

4. The method claim 1 wherein the computer generated graphical environment is integrated with a plurality of trading software applications.

5. The method claim 1 wherein one of the widgets includes a first widget and one of the components includes a first component, wherein the first component is a second stock trading algorithm.

6. The method of claim 1 wherein the component of the event algorithm is selected from the group consisting of a ratio, a security, a price, a logical operator, a second stock trading algorithm, a Boolean operator, an event of interest, and a conditional operator.

7. The method of claim 1 further comprising the steps of processing administrative operations using a control node executing on a first server, running the event algorithm on a second server, and executing the action using a third server, the action relating to a stock.

8. The method of claim 1 further comprising the step of combining the plurality of widgets on a client-side device.

9. The method of claim 8 further comprising the step of transforming the combined widgets into a computer readable code version of the combined widgets using a server.

10. A computer-based system of executing an action comprising:
a server configured to transmit and receive trading data, wherein the server is geographically proximal to a trading exchange, wherein the server comprises a processor, the processor programmed to
receive trading data comprising a trade order for a security transmitted from a device programmed with a trading algorithm, the trading algorithm generated using a plurality of drag and droppable widgets, each icon displayed as a widget in a browser, each icon associated with a component of the trading algorithm; and
execute the action using a transformed version of a combination of the plurality of widgets such that the security is traded within a time period P, wherein the action is a trade order.

11. The system of claim 10 wherein the server is programmed to report the execution of the trade order to the device.

12. The system of claim 10 wherein P ranges from about 0.1 milliseconds to about 10 milliseconds.

13. The system of claim 10 further comprising a widget translator configured to generate the transformed version of the combination of the plurality of widgets.

14. A computer-based transaction system comprising:
a memory storage device comprising an algorithmic trading software application, the application comprising,
a graphic user interface comprising an active region and an algorithm builder interface;
a library comprising a plurality of trading algorithm components, each component corresponding to a widget when placed in the active region;
a set of widgets linked to one of the plurality of trading algorithm components;
a user input monitor configured to detect selection and arrangement of each widget within the active area; and
a widget translator configured to process a finalized trading algorithm and transmit any output trading orders resulting from executing the finalized trading algorithm to a proximity server.

15. The system of claim 14 wherein the finalized trading algorithm is a transformed computer readable code of a plurality of widgets.

16. The system of claim 14 wherein the active area and widgets are displayed within a browser.

17. The system of claim 14 wherein one component is selected from the group consisting of a ratio, a security, a price, a logical operator, a second stock trading algorithm, a Boolean operator, an event of interest, and a conditional operator.

18. The system of claim 14 wherein one or more widgets are combined on a client-side device before being transformed at a server.

19. The system of claim 14 wherein the graphical user interface is integrated with a plurality of trading software applications.

20. The system of claim 14 wherein the finalized trading algorithm is configured to have a first input populated by a real time stream of data.

21. The system of claim 14 wherein one or more events or states detected in the real time stream of data cause a trade to be executed by the finalized trading algorithm.
